(19) United States
(12) Patent Application Publication
(10) Pub. No.: US 2017/0357815 A1
(43) Pub. Date: Dec. 14, 2017

(54) CODE OBFUSCATION AND UNIQUE INSTANCES

(71) Applicant: Lior Malka, San Jose, CA (US)

(72) Inventor: Lior Malka, San Jose, CA (US)

(21) Appl. No.: 15/179,029

(22) Filed: Jun. 10, 2016

(51) Int. Cl. G06F 21/60

(52) U.S. Cl. CPC G06F 21/602; H04L 2209/16

(57) ABSTRACT

Obfuscation transforms original code into an obfuscated code that is less intelligible, but behaves like the original. In one embodiment, a code representation obtained by applying a code template to input data is given to a code host that selects a location for the code representation and returns a reference. The reference can be used to replace the data and thus may be used for code obfuscation. The original code may not be required or modified. In another embodiment, a method is described that receives requests, either from a human or a device, and provides unique executable obfuscated instances along with unique data files.

### BACKGROUND

In the current design of computers, it is possible to inspect code before and during execution. The information obtained can be used to reverse engineer, modify, or attack the code. Obfuscation is a technique for mitigating this issue. Obfuscation transforms original code into an obfuscated code. The obfuscated code is less intelligible, but behaves like the original. Various obfuscation techniques have been proposed. Some apply to source code and some apply to compiled code, while others apply to both. Obfuscation techniques integrated into the compiler have also been proposed. A disadvantage of existing obfuscators is that the original code must exist in order for the obfuscator to produce an obfuscated code. Moreover, the obfuscator must parse and preprocess the original code in order to produce an obfuscated code. Systems using obfuscation have also been proposed. In these systems, all users receive the same obfuscated instance, or each user receives a different obfuscated instance coupled with a program that allows the instance to be operable. Due to the complexity of implementing unique instances per user, existing obfuscation systems do not take full advantage of the benefits of obfuscation.

### SUMMARY

Embodiments are provided for code obfuscation. In one embodiment, a code representation is obtained when a code template is applied to data. A code host selects a location for the code representation and returns a reference. The reference can be used to replace the data and thus may be used for code obfuscation. The original code may not be required. In another embodiment, unique obfuscated instances are provided when requests are received.

### DRAWINGS

The following figures illustrate the embodiments by way of example. They do not limit their scope.

FIG. 1 shows a flow diagram of a method of code obfuscation, in accordance with one embodiment.

FIG. 2 shows a flow diagram of a method of code templating, in accordance with one embodiment.

FIG. 3 shows a flow diagram of a method of providing different instances of obfuscated code, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

Obfuscation is a transformation from code in one domain to another code in the same or another domain. The code may be in source form or in binary form. Binary form describes any code that is not source code. It includes, but is not limited to, object form, machine code, and microcode. The transformed code is intended to be less intelligible than the original code, while preserving the original code behavior.

A parsing obfuscation is an obfuscation that requires the original code in order to produce transformed code. It parses the original code. A referencing obfuscation is an obfuscation that does not require parsing of the original code and may not require the original code at all. A referencing obfuscation creates new code from existing code templates. The output of a referencing obfuscation is called a reference construct. The reference construct includes a reference to a function that would execute the code template. The code template may return a value, possibly void. The changes that would need to be made to the original code in order to incorporate the reference and the code it depends on may be included in the reference construct or they can be included elsewhere. Transformed code is created when these changes are applied. The changes may add new code that may or may not reference the original code, or they may modify a copy of the original code, or both.

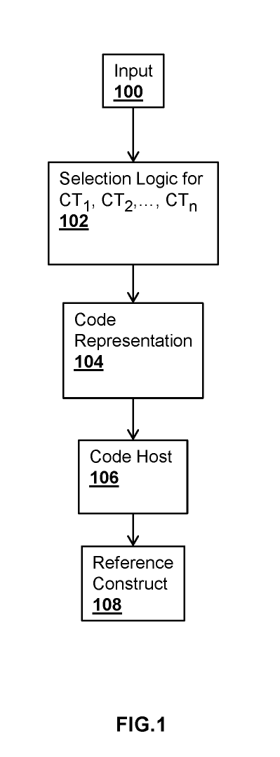

FIG. 1 shows a flow diagram of a method of code obfuscation, in accordance with one embodiment. The input 100 to the method contains data of a given type. For example, the type may be integer and the data could be the integer 1234. A selection logic 102 containing a plurality of code templating units for the type selects a code templating unit, applies the unit to the data, and obtains a code representation 104. To illustrate, when applied to the integer 1234, a code template unit that breaks an integer into two parts may return a representation of a function whose return type is “int” and whose body is shown below.

int x=1000+234;

return x;

The selection logic 102 may select a code templating unit in any way, including random and fixed selection. The type of the data contained in the input 100 can be any type permitted by the code, including “void” and user defined types.

A code host 106 takes the code representation 104, selects a location for the code representation, and returns a reference construct 108 as output. A reference construct contains a reference to the code representation, and may optionally include a description of the changes that would need to be made to the original code in order to incorporate the reference and the code the reference depends on. The location selected by the code host 106 can be a new file or it can be selected from a list of files, or both. Furthermore, the selection can be random or fixed and the locations used by the code host 106 may represent files that do not exist. For example, suppose that the exemplary code template unit mentioned earlier is used to obfuscate the integer 1234 in the code below:

int f(int y) {

if (y == 1234)

return 0;

else

return 1;

}

Further, suppose that the code host selects the same file to be the location for the code representation and that it uses “a1” as a reference. The obfuscated code may then be as below.

int a1( ) {

int x = 1000 + 234;
return x;

}
int f(int y) {

if (y == a1( ))

return 0;

else

return 1;

}

A description of the changes that would need to be made to the original code in order to incorporate the reference may be included in the reference construct 108. This description can be used to produce the obfuscated code, but neither the application of these changes nor the existence of the original code is required by the method.

In another embodiment, the input 100 may also contain an iteration counter, a code template unit may invoke obfuscators on elements from its code template and substitute the elements with reference constructs obtained from the obfuscators. Such code template units may be referred to as recursive. The selection logic 102 would choose a recursive code template unit only if the counter has not reached a threshold. As an example, using the above code, a code template unit whose code template contains the line “int x=1000+234” may produce a code representation containing the code “int x=a2( )+a3( )”, where “a2( )” and “a3( )” are references obtained by obfuscating the integers 1000 and 234, respectively.

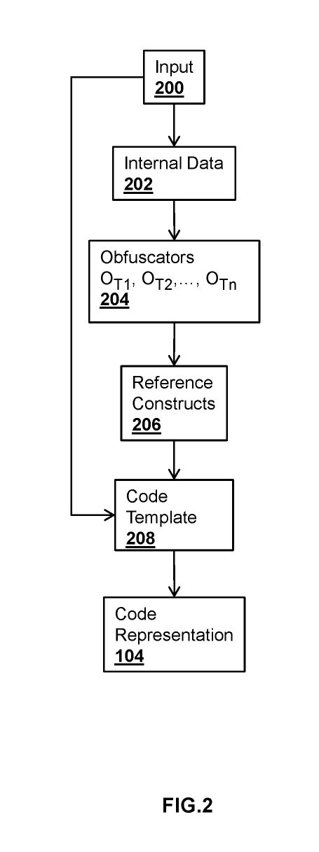

FIG. 2 shows a flow diagram of a method of code templating, in accordance with one embodiment. The input 200 includes zero or more elements of different types. For example, the input may include the integer 1234. Alternatively, it may include a reference construct 108, in which case the element is directly embedded in the code template 208. Or, the input may include both, or none. The method may or may not produce internal data 202. For example, to break the integer 1234 into two parts, it may choose a random integer, say 1000, and then choose to break 1234 into two integers 1000 and 234. The method may be equipped with obfuscators 204 for difference data types. If the obfuscators require an iteration counter or a code host, then those would be included in the input 200. Internal data 202, when obfuscated using the obfuscators, would produce reference constructs 206 which are then embedded in the code template 208 to produce a code representation 104 as output. For example, the internal data “1000” and “234” may become reference constructs containing the references “a2( )” and “a3( )”, respectively, and a code template “int x=1000+234” embedding them may produce a code representation containing “int x=a2( )+a3( )”.

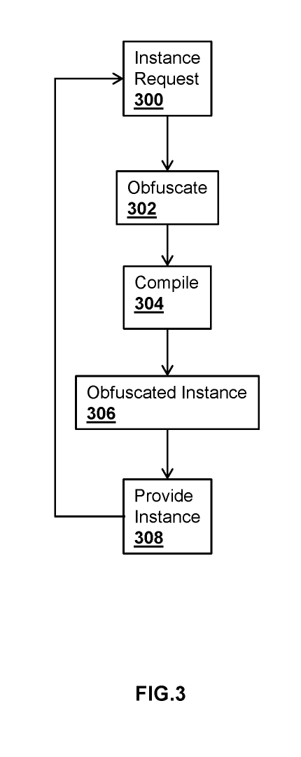

FIG. 3 shows a flow diagram of a method of providing different instances of obfuscated code for a given original code, in accordance with one embodiment. The method receives a request 300 for an obfuscated instance. The request can be made by a human or by a device and may arrive in any way and in particular over a network. An obfuscator is used to obfuscate 302 the original code. The obfuscated code is compiled 304 to create an executable obfuscated instance 306. The obfuscated instance 306 is then provided 308 to the recipient, and the method handles the next request 300.

The obfuscator may use random or different inputs so that a unique obfuscated instance 306 is created for each request 300. However, it can also be configured to use the same input. The original code may also have files containing data. The data files may contain, for example, a unique identifier and a password. It may also contain cryptographic material, which includes, but is not limited to, a description of keys and algorithms used in encryption, signatures, and other cryptographic algorithms. The data may be included in the instance request 300 or determined by the method, or both. The data may be identical or different for each request. Thus, the obfuscated instance 308 may have unique code and unique data files. As an example, a user, making three instance requests from the same device, may be provided with three unique obfuscated instances, and the data files of each instance may have a combination of similar data, such as a username, and unique data, such as the cryptographic material chosen by the method.

The method can use any obfuscator, regardless of whether it applies to source code or binary code. If the obfuscator produces as output a description of the changes that would need to be made to the original code in order to create an obfuscated instance, then the changes are applied prior to compilation 304. If the obfuscator modifies the original code, then the obfuscation should be applied to a copy of the original code. If the obfuscator creates a new program that only references the original code, then no changes are made to the original code, and the method does not require the original code to exist. Thus, the method can be used with only a compiled version of the original code, and a source version of the original code may not be required.

The specific embodiments and specific terminology used above should not be construed as limiting the scope of the embodiments. These details have been presented for purposes of illustration and are not intended to be exhaustive. Many modifications and uses are possible. The scope of the embodiments is defined by the Claims appended hereto and their equivalents.

What is claimed is:

1. A method of obfuscating computer code, the method comprising:
receiving input containing data; and
selecting a code templating unit from a plurality of code templating units; and
applying the templating unit to the data to receive a code representation; and
applying a code host to the code representation to receive a reference construct;
and outputting the reference construct.

2. The method of claim 1, further comprising producing obfuscated code using the reference from the reference construct and code that the reference depends on.

3. The method of claim 1, wherein a code templating unit is selected randomly.

4. The method of claim 1, wherein a code templating unit replaces elements in its code template with reference constructs obtained by obfuscating the elements.

5. The method of claim 1, wherein the input includes an iteration counter and a recursive code templating unit is selected only if the counter has not reached a threshold.

6. The method of claim 1, wherein the input includes the code host.

7. The method of claim 1, wherein the code host randomly chooses a location for the code representation from a set of new files.

8. A method of code templating, the method comprising:
receiving data as input; and
obfuscating the data using obfuscators to obtain reference constructs; and
embedding the reference constructs in a code template to produce a code representation; and
outputting the code representation.

9. The method of claim 8, wherein the reference constructs include a second set of reference constructs provided as part of the input.

10. The method of claim 8, wherein the input data is decomposed into internal data prior to being obfuscated.

11. The method of claim 8, wherein the input includes an iteration counter.

12. The method of claim 8, wherein the input includes a code host.

13. A method of providing unique instances of obfuscated code,
the method comprising:
receiving from a recipient a request for an obfuscated instance; and
using an obfuscator to create an obfuscated instance; and
compiling the obfuscated instance to obtain an executable obfuscated instance;
and providing the executable obfuscated instance to the recipient;

14. The method of claim 13, wherein the instance request includes additional data.

15. The method of claim 13, wherein the input for the obfuscator is chosen randomly.

16. The method of claim 13, wherein the obfuscator is a referencing obfuscator.

17. The method of claim 13, wherein the executable obfuscated instance includes data files.
